(19) United States
(12) Patent Application Publication
(10) Pub. No.: US 2026/0163671 A1
(43) Pub. Date: Jun. 11, 2026

(54) LOW LATENCY ERROR DETECTION AND RECOVERY MECHANISM FOR IMAGE SIGNAL PROCESSOR

(71) Applicant: QUALCOMM Incorporated, San Diego, CA (US)

(72) Inventors: Aakil Mahendra BAPNA, Bangalore (IN); Abhijeet DEY, Bengaluru (IN); Vijayamanohar NAGARAJAN, Bangalore (IN); Rahul GULATI, San Diego, CA (US); Joby ABRAHAM, Bangalore (IN)

(21) Appl. No.: 18/970,689

(22) Filed: Dec. 5, 2024

(51) Int. Cl. H04L 1/00

(52) U.S. Cl. CPC H04L 1/0039; H04L 1/0083

(57) ABSTRACT

A method for low latency error detection and recovery is described. The method includes monitoring a serial data stream received at an image signal processor (ISP). The method also includes detecting an error status packet in the serial data stream. The method further includes determining a recovery according to a decoded error type from the error status packet. The method also includes initiating the recovery in the ISP.

### BACKGROUND

### Field

Aspects of the present disclosure relate to error recovery, and to a system and method for a low latency error detection and recovery mechanisms for an image signal processor.

### Background

Vehicle or automotive control systems may be subject to more stringent operational requirements. This is because errors in such vehicle or automotive control systems may result in severe injury or death to humans occupying associated vehicles, as well as humans, animals, and property that may collide with such vehicles. Such stringent operational requirements may address system redundancy, greater resistance to electrical and software faults, and improved monitoring of such systems, to name a few issues. Increasing requirements in advanced driver assistance systems (ADAS) as well as autonomous driving (AD) systems demand development of an end-to-end low latency mechanism to improve an overall safety rating. A system and method for a low latency error detection and recovery mechanism is desired.

### SUMMARY

A method for low latency error detection and recovery is described. The method includes monitoring a serial data stream received at an image signal processor (ISP). The method also includes detecting an error status packet in the serial data stream. The method further includes determining a recovery according to a decoded error type from the error status packet. The method also includes initiating the recovery in the ISP.

A method for low latency error detection and recovery is described. The method includes reading an error status in response to a detected interrupt request (IRQ). The method also includes generating an error status packet in response to the error status. The method further includes monitoring a serial data stream transmitted to an image signal processor. The method also includes transmitting the error status packet in a detected blanking interval of the serial data stream.

An apparatus for low latency error detection and recovery is described. The apparatus includes at least one memory and at least one processor coupled to the at least one memory. The at least one processor configured to read an error status in response to a detected interrupt request (IRQ). The at least one processor is also configured to generate an error status packet in response to the error status. The at least one processor is further configured to monitor a serial data stream transmitted to an image signal processor. The at least one processor is also configured to transmit the error status packet in a detected blanking interval of the serial data stream.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for low latency error detection and recovery, in accordance with various aspects of the present disclosure.

FIG. 2 is a block diagram further illustrating the system-on-chip (SoC) of FIG. 1, including a CPU subsystem configured for a low latency error detection and recovery mechanism for an image signal processor (ISP), according to various aspects of the present disclosure.

FIG. 3 is a data-flow diagram illustrating a low latency error detection and recovery process in the end-to-end ISP subsystem of FIG. 2, according to various aspects of the present disclosure.

FIG. 4 is a block diagram illustrating a serializer having an error detection (EDT) module, according to various aspects of the present disclosure.

FIG. 5 is a block diagram illustrating an image signal processor (ISP) having an error reception and control (ERC) module, according to various aspects of the present disclosure.

FIG. 6 is a process flow diagram illustrating a method for low latency error detection and recovery, according to various aspects of the present disclosure.

FIG. 7 is a block diagram showing an exemplary wireless communications system in which a configuration of the disclosure may be advantageously employed.

FIG. 8 is a block diagram illustrating a design workstation used for circuit, layout, and logic design of a semiconductor component, such as that of the low latency error detection and recovery technique disclosed herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced. Similarly, the terms “chip” and “die” may be used interchangeably.

Vehicle or automotive control systems may be subject to more stringent operational requirements. This is because errors in such vehicle or automotive control systems may result in severe injury or death to humans occupying associated vehicles, as well as humans, animals, and property that may collide with such vehicles. Such stringent operational requirements may address system redundancy, greater resistance to electrical and software faults, and improved monitoring of such systems, to name a few issues. Increasing requirements in advanced driver assistance systems (ADAS) as well as autonomous driving (AD) systems demand development of an end-to-end low latency mechanism to improve an overall safety rating.

For example, definitions as per the international organization for standard (ISO) ISO26262: a hazardous event is defined as the starting point where harm can occur to the user due to random hardware failures. The time span between a fault and the hazardous event is called ‘Fault Tolerant Time Interval (FTTI)’ and is used to define the worst-case reaction time of the system to be functionally safe. The time span required to detect a fault is known as ‘Fault Detection Time Interval (FDTI)’ and the time span needed for the actual transfer to safe state is called ‘Fault Reaction Time Interval (FRTI).’ Fault Handling Time Interval (FHTI) is the sum of detection and reaction time (e.g., FHTI=FDTI+FRTI). In short, any increase in FDTI or FRTI, or both, increases the FHTI. If the FHTI is increased to the FTTI, this increase of the FHTI leads to a hazardous event, which may be catastrophic. A system and method for a low latency error detection and recovery mechanism is desired.

Various aspects of the present disclosure are directed to a system and method for a low latency error detection and recovery mechanism. A recovery method includes monitoring a serial data stream received at an image signal processor (ISP). For example, the serial data steam is monitored by a serializer/deserializer between the ISP and a sensor. The recovery method further includes detecting an error status packet in the serial data stream by the serializer/deserializer. Once detected, the recovery method further includes determining a recovery according to a decoded error type from the error status packet. The recovery method also includes initiating the recovery in the ISP.

According to various aspects of the present disclosure, the system and method for a low latency error detection and recovery mechanism includes an error detection method. The error detection method includes reading an error status in response to a detected interrupt request (IRQ). For example, a serializer/deserializer between the ISP and a sensor detects the IRQ. The error detection method further includes generating an error status packet in response to the error status by the serializer/deserializer (e.g., a serializer status (SER status) or a de-serializer status (DES status)). Once generated, the error detection method includes monitoring a serial data stream transmitted to the ISP. Additionally, the error detection method includes transmitting the error status packet in a detected blanking interval of the serial data stream.

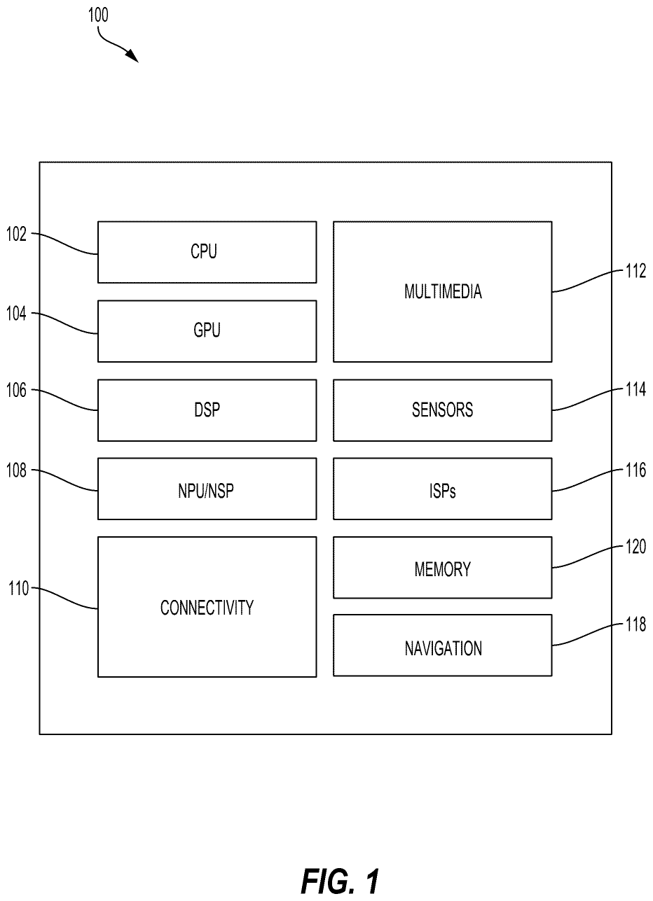

FIG. 1 illustrates an example implementation of a host system-on-chip (SoC) 100, which is configured for low latency error detection and recovery, in accordance with various aspects of the present disclosure. The SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SoC 100 includes various processing units that support multi-threaded operation. For the configuration shown in FIG. 1, the SoC 100 includes a multi-core central processing unit (CPU) 102, a graphics processor unit (GPU) 104, a digital signal processor (DSP) 106, and a neural processor unit (NPU)/neural signal processor (NSP) 108. The SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU/NSP 108 may be based on an ARM instruction set.

The SoC 100 may include a set of subsystems (not shown) to perform various operations in accordance with the design specification for the SoC 100. For example, in the case of automotive control, the set of subsystems may include semi-autonomous or autonomous driving subsystems (e.g., advanced driver assistance systems (ADAS)), such as forward collision warning (FCW), lane departure warning (LDW), blind spot detection (BSD) subsystems (e.g., ADAS level “0” subsystems); adaptive cruise control (ACC) and lane keep assist (LKA) subsystems (e.g., ADAS level “1” subsystems); ACC with lane keeping and traffic jam assist subsystems (e.g., ADAS level “2” subsystems); highway autopilot and traffic jam pilot subsystems (e.g., ADAS level “3” subsystems); full highway autopilot and full urban autopilot subsystems (e.g., ADAS level “4” subsystems); and robo-taxi/shuttles and autonomous delivery fleet subsystems (e.g., ADAS level “5” subsystems).

Vehicle or automotive control systems may be subject to more stringent operational requirements. This is because errors in such vehicle or automotive control systems may result in severe injury or death to humans occupying associated vehicles, as well as humans, animals, and property that may collide with such vehicles. Such stringent operational requirements may address system redundancy, greater resistance to electrical and software faults, and improved monitoring of such systems, to name a few issues. Increasing requirements in advanced driver assistance systems (ADAS) as well as autonomous driving (AD) systems demand development of an end-to-end low latency mechanism to improve an overall safety rating. A system and method for a low latency error detection and recovery mechanism to improve an overall safety rating is desired.

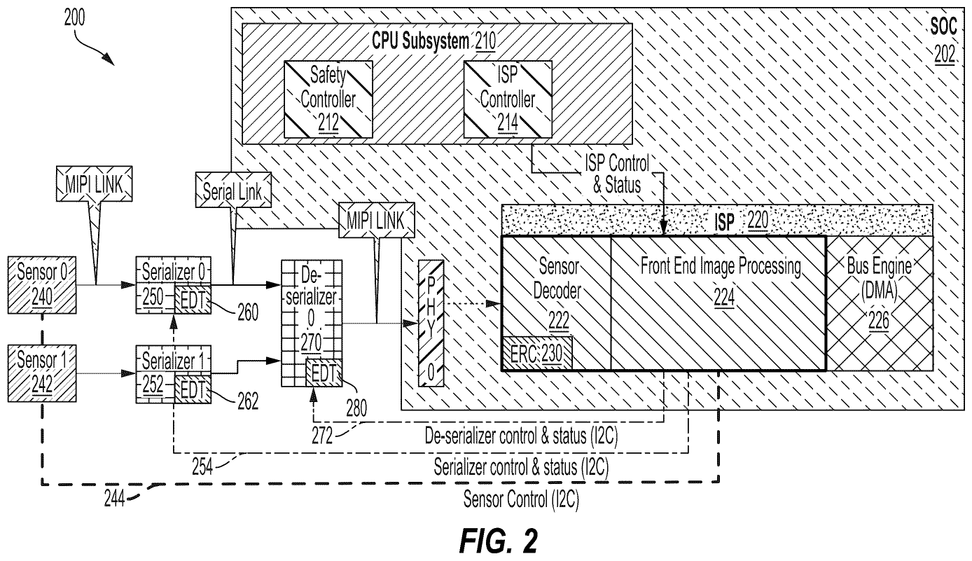

FIG. 2 is a block diagram further illustrating the system-on-chip (SoC) of FIG. 1, including a central processing unit (CPU) subsystem configured for a low latency error detection and recovery mechanism for an image signal processor (ISP), according to various aspects of the present disclosure. As shown in FIG. 2, the system-on-chip (SoC) 202 includes a safety controller 212 and an ISP controller 214 configured for low latency error detection and recovery for an ISP 220 (e.g., the ISP 116 of FIG. 1). In this example, the ISP 220 includes a sensor decoder 222, a front-end image processing module 224, and a bus engine 226 (e.g., direct memory access (DMA)). The safety controller 212 may implement an advanced driver assistance system (ADAS)/autonomous driving (AD) system, which relies on an end-to-end low latency mechanism to achieve a desired overall safety rating.

For example, as defined by the international organization for standard (ISO) ISO26262: a hazardous event is defined as the starting point where harm can occur to the user due to random hardware failures. The time span between a fault and the hazardous event is called ‘Fault Tolerant Time Interval (FTTI)’ and is used to define the worst-case reaction time of the system to be functionally safe. The time span required to detect a fault is known as ‘Fault Detection Time Interval (FDTI)’ and the time span needed for the actual transfer to safe state is called ‘Fault Reaction Time Interval (FRTI).’ Fault Handling Time Interval (FHTI) is the sum of detection and reaction time (e.g., FHTI=FDTI+FRTI). In short, any increase in FDTI or FRTI, or both, increases the FHTI. If the FHTI is increased to the FTTI, this increase of the FHTI leads to a hazardous event, which may be catastrophic.

Conventional ISP architectures suffer from high latency due to a slow interface. Additionally, conventional ISP architectures are heavily software dependent for performing error detection and recovery because the ISP is unaware of errors in a serializer (SER)-deserializer (DES) (SER-DES) between the ISP and one or more sensors. In these conventional ISP architectures, sensor, serializer, and de-serializer use of a high-speed data link is limited to data transfer to the ISP. In short, control status information is communicated via a low-speed interface (e.g., an inter-integrated circuit I2C interface).

Various aspects of the present disclosure are directed to improving an overall safety rating for an end-to-end ISP subsystem by defining a low latency mechanism to reduce error detection (FDTI) and recovery time (FRTI). In some implementations, an existing high-speed link is utilized for transferring status information directly to the ISP 220, which provides a significant reduction in the error detection time (FDTI). In this implementation, an error reception and recovery (ERC) module 230 of the ISP 220 promptly initiates a recovery process as soon as error status is received, which reduces the FRTI.

As shown in FIG. 2, an end-to-end ISP subsystem 200 begins with a first sensor 240 (e.g., Sensor 0) coupled to a first serializer 250 (e.g., Serializer 0), and a second sensor 242 (e.g., Sensor 1) coupled to a second serializer 252 (e.g., Serializer 1) through a first high-speed link (e.g., a mobile industry processor interface (MIPI)). Additionally, the first serializer 250 and the second serializer 252 (e.g., Serializer 1) are coupled to a de-serializer 270 through respective high-speed serial data links. In this example, the first sensor 240 and the second sensor 242 are configured according to a sensor control signal 244 received from the front-end image processing module 224 of the ISP 220. Additionally, the first serializer 250 and the second serializer 252 are configured according to a serializer control and status signal 254. Similarly, the de-serializer 270 is configured according to a de-serializer control and status signal 272.

According to various aspects of the present disclosure, the first serializer 250 is configured with error detection and transmission (EDT) logic 260 and the second serializer 252 is configured with error detection transmission (EDT) logic 262. The de-serializer 270 is configured with EDT logic 280. In operation, the EDT logic 260/262/280 are configured to perform an error detection process, which begins by reading an error status in response to a detected interrupt request (IRQ). In response to the detected IRQ, the EDT logic 260/262/280 are configured to generate an error status packet, which may be configured according to a MIPI format. Once generated, the EDT logic 260/262/280 monitor the high-speed serial data link to detect a blanking interval. In this example, the EDT logic 260/262/280 insert the error status packet in a detected blanking interval of a serial data stream.

As shown in FIG. 2, the error status packet is eventually transmitted over a second high-speed link (e.g., a mobile industry processor interface (MIPI) link) to a physical layer PHY 0 of the SoC 202 and to the sensor decoder 222 of the ISP 220. According to various aspects of the present disclosure, the error status packet is subsequently received by the ERC module 230 of the sensor decoder 222. The ERC module 230 of the sensor decoder 222 is configured to perform a recovery process by monitoring a serial data stream received at the sensor decoder 222. The ERC module 230 detects the error status packet in the serial data stream from the EDT logic 260/262/280. Once detected, the ERC module 230 determines a recovery according to a decoded error type from the error status packet to initiate the recovery in the ISP 220. For example, the recovery may include programming a configuration space for the sensors 240/242, the serializers 250/252, and/or the de-serializer 270 for reset synchronization, and error logging.

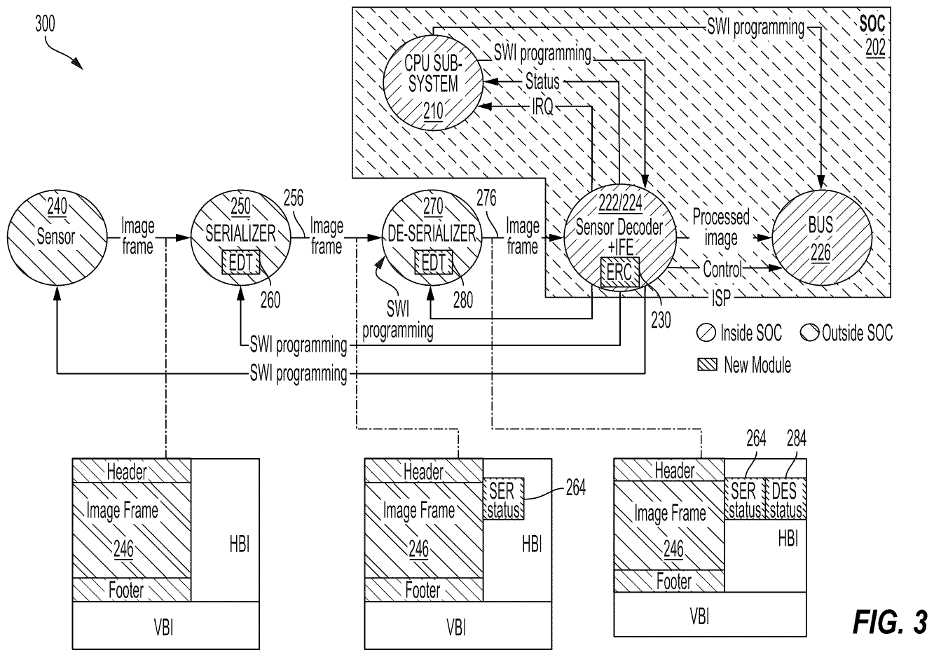

FIG. 3 is a data-flow diagram 300 illustrating a low latency error detection and recovery process in the end-to-end ISP subsystem 200 of FIG. 2, according to various aspects of the present disclosure. As shown in FIG. 3, operation of the end-to-end ISP subsystem 200 includes an initialization phase, a mission mode phase, and an error phase.

After system boot-up or post system reset, software (SW) of the CPU subsystem 210 loads an initialization configuration for the first sensor 240, the first serializer 250, and the de-serializer 270 to memory in the ERC module 230 during the initialization phase. Additionally, the ISP 220 programs the first sensor 240, the first serializer 250, and the de-serializer 270 via a low-speed interface (I2C) according to the initialization configuration. An advance high-performance bus (AHB) may be used to program the ISP 220 and the bus engine 226. A configuration of the first sensor 240 is also written to the ISP 220 by the SW of the CPU subsystem 210.

The sequence of events following the reset/power include the configuration of the first sensor 240, the first serializer 250, and the de-serializer 270 via the ISP 220, in which these configurations are stored in the ERC module 230. Additionally, following configuration of the ISP 220 and the bus engine 226, the system enters a mission mode phase. During the mission mode phase, after the configuration is completed, the system is ready to begin operation. In various aspects of the present disclosure, programming of the first serializer 250 and the de-serializer 270 is performed through the ISP 220, rather than the CPU subsystem 210, for entry into mission mode.

During operation in the mission mode, the first sensor 240 captures an image and sends an image frame 246 over the first high-speed link to the first serializer 250. In this example, the image frame 246 is packetized according to a predetermined packet format (e.g., a mobile industry processor interface (MIPI) packet format), which includes a header and a footer. Additionally, a horizontal blanking interval (HBI) and a vertical blanking interval (VBI) are shown relative to the image frame 246. In various aspects of the present disclosure, the first serializer 250 inserts a serializer (SER) status 264 in the HBI associated with the image frame 246. In response, the first serializer 250 converts the image frame 246 into a serial packet 256 and sends the serial packet 256 over the high-speed serial link to the de-serializer 270.

As shown in FIG. 3, the de-serializer 270 converts the serial packet 256 to a frame packet 276 (e.g., MIPI packet), which includes the image frame 246, a header, and a footer, which are shown relative to the HBI and the VBI. Additionally, the de-serializer 270 inserts a de-serializer (DES) status 284 in the HBI associated with the frame packet 276 and sends the frame packet 276 to the PHY 0. In response, the sensor decoder 222 extracts the image frame 246 from the frame packet 276 and sends the image frame 246 to the ISP 220. The front-end image processing module 224 of the ISP 220 processes the image frame 246 and sends the processed image to the bus engine 226, which packs the processed image and sends the packed processed image to memory (not shown).

During the error phase, when an error is detected by the EDT module 260/280, the EDT module 260/280 reads an error status and creates an error status packet (e.g., MIPI packet) with a specific virtual channel (VC)/data type (DT). Subsequently, the EDT module 260/280 monitors internal data to identify a blanking region. Once the blanking region is detected, the EDT module 260/280 inserts the error status packet (e.g., the SER status 264 and/or the DES status 284), which is transmitted in the HBI downstream via the high-speed serial link, which reduces the FDTI (Fault Detection Time Interval).

As shown in FIG. 3, the ERC module 230 is configured to identify a status packet (e.g., SER status 264 and/or DES status 284) in a detected blanking interval of the frame packet 276. Once detected, the ERC module 230 analyzes the status packet to determine whether the status packet is an error status packet based on the SER status 264 and/or DES status 284. Once a status packet is identified and the SER status 264 and/or DES status 284 is determined, the status packet is dropped. In this example, the presence of the SER status 264 and/or DES status 284 does not indicate the presence of an error and may indicate error free operation.

In response, the sensor decoder 222 identifies an error status packet based on VC/DT and routes the error status packet to the ERC module 230. In this example, the ERC module 230 reads the error status packet and determines a recovery action. Additionally, the ERC module 230 logs the error and informs a safety manager. For example, the ERC module 230 may initiate a reset as the recovery action. In the case of a reset, the ERC module 230 programs the first sensor 240, the first serializer 250, and the de-serializer 270 with last programmed configuration values after a reset completion notification is received. This recovery process is performed without intervention from the SW of the CPU subsystem 210, which reduces the FRTI (Fault Reaction Time Interval).

As an example, the sequence of events that occur during error detection includes detection of a generated interrupt request (IRQ) by the EDT 260/280. In response, the EDT 260/280 reads an error status of the IRQ and generates an error status packet (e.g., MIPI). Once generated, the EDT 260/280 identifies a blanking window and inserts the error status packet in the identified blanking window. Subsequently, the sensor decoder 222 identifies the error status packet and sends the error status packet to the ERC module 230. In this example, the ERC module 230 decodes the error status packet and determines a recovery action (e.g., a pre-programmed action based on errors).

According to various aspects of the present disclosure, the ERC module 230 initiates the recovery action by programming the first sensor 240, the first serializer 250, and the de-serializer 270 (e.g., for a reset recovery action). Subsequently, the ERC module 230 logs the error and informs the safety manager while waiting for recovery completion. During the reset recovery action, the ERC module re-programs the first sensor 240, the first serializer 250, and the de-serializer 270 using a last used configuration for transitioning to the mission mode. The noted low latency error detection and recovery process reduces both the FDTI and FRTI, which results in a significant reduction of the FTTI, thereby improving system safety.

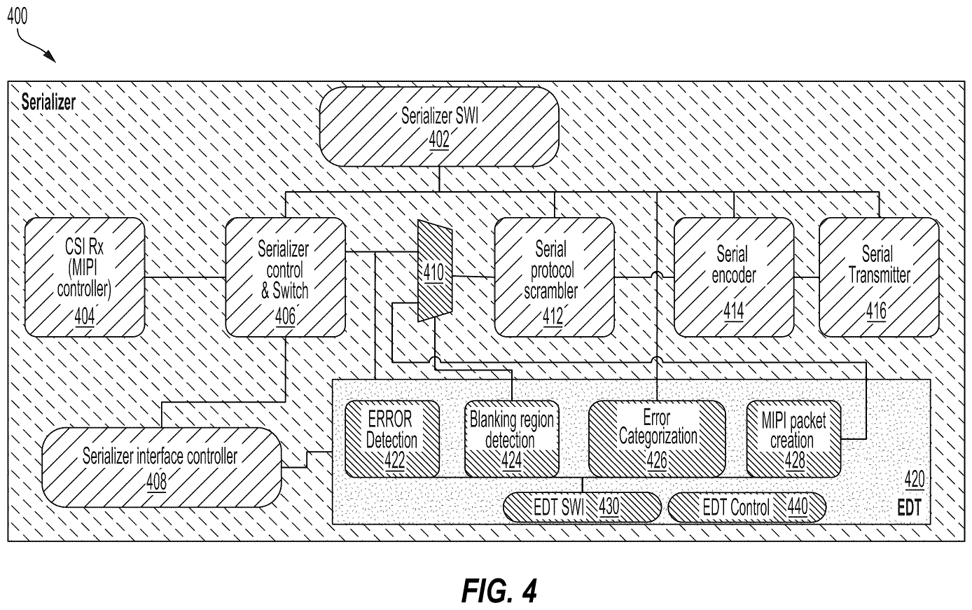

FIG. 4 is a block diagram illustrating a serializer having an error detection (EDT) module, according to various aspects of the present disclosure. As shown in FIG. 4, the serializer 400 includes a serializer software interface (SWI) 402, a camera serial interface (CSI) receiver (Rx) 404, a serializer control and switch 406, and a serializer interface controller 408. During an error detection phase, a multiplexor 410 is provided in combination with an EDT module 420. The EDT module 420 includes an error detection block 422, a blanking region detection block 424, an error categorization block 426, and an error packet creation block 428.

In this example, operation of the EDT module 420 is performed according to an EDT SWI 430 and an EDT controller 440. In this example, in response to a detected error at the error detection block 422, an error packet is generated by the error packet creation block 428 according to the error categorization block 426 and inserted into a blanking region detected by the blanking region detection block 424. The multiplexer enables insertion of the error packet into the detected blanking region, which is provided to a serial protocol scramble block 412, followed by a serial encoder 414, and a serial transmitter 416. Configuration of a de-serializer, such as the de-serializer 270 shown in FIGS. 2 and 3 may be like the serializer 400 of FIG. 4 to include the EDT logic 280.

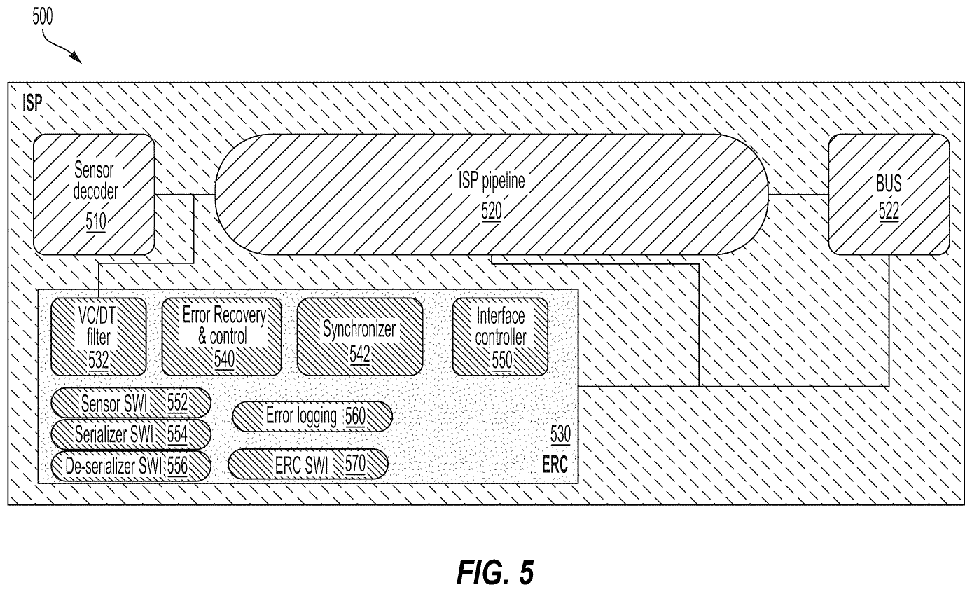

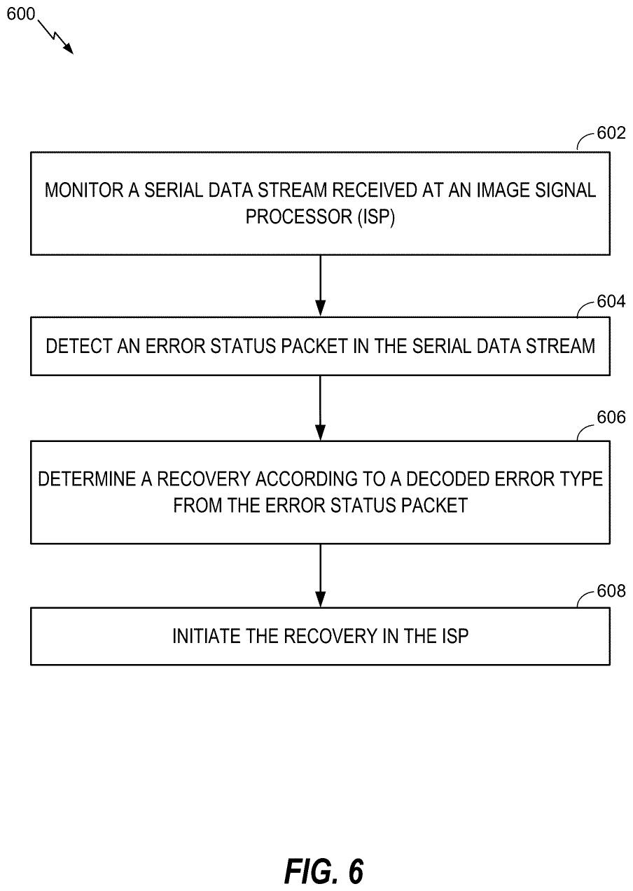

FIG. 5 is a block diagram illustrating an image signal processor (ISP) 500 having an error reception and control (ERC) module 530, according to various aspects of the present disclosure. As shown in FIG. 5, the ISP 500 includes a sensor decoder 510, an ISP pipeline 520, a bus 522, and the ERC module 530. In operation, a virtual channel (VC)/data type (DT) filter 532 of the ERC module 530 monitors an image frame from the sensor decoder 510 to detect an error packet according to a predetermined value of the VC/DT filter 532. When an error packet is detected, the error packet is provided to an error recovery and control module 540. The error recovery and control module 540 utilizes a synchronizer 542 as well as an interface controller 550 to perform a selected error recovery action, as well as logging of the error using an error logging module 560. Additionally, the ERC module 530 utilizes a sensor software interface (SWI) 552, a serializer SWI 554, a de-serializer SWI 556, and an ERC SWI 570 to perform the selected error recovery action. A process for low latency error detection and recovery is shown, for example, in FIG. 6.

FIG. 6 is a process flow diagram illustrating a method 600 for low latency error detection and recovery, according to various aspects of the present disclosure. The method 600 begins at block 602, in which a serial data stream received at an image signal processor (ISP) is monitored. For example, as shown in FIG. 3, an existing high-speed link is utilized for transferring status information directly to the ISP 220, which provides a significant reduction in the error detection time (FDTI). In this implementation, an error reception and recovery (ERC) module 230 of the ISP 220 monitors a serial data stream received at the ISP 220.

At block 604, an error status packet is detected in the serial data stream. For example, as shown in FIG. 3, the error status packet is subsequently received by the ERC module 230 of the sensor decoder 222. The ERC module 230 of the sensor decoder 222 is configured to monitor the serial data stream received at the sensor decoder 222. The ERC module 230 detects the error status packet in the serial data stream from the EDT logic 260/262/280.

At block 606, a recovery is determined according to a decoded error type from the error status packet. For example, as shown in FIG. 3, The ERC module 230 of the sensor decoder 222 is configured to perform a recovery process by monitoring a serial data stream received at the sensor decoder 222. The ERC module 230 detects the error status packet in the serial data stream from the EDT logic 260/262/280. Once detected, the ERC module 230 determines a recovery according to a decoded error type from the error status packet.

At block 608, the recovery is initiated in the ISP. For example, as shown in FIG. 3, once the error status packet is detected, the ERC module 230 determines a recovery according to a decoded error type from the error status packet to initiate the recovery in the ISP 220. For example, the recovery may include programming a configuration space for the sensors 240/242, the serializers 250/252, and/or the de-serializer 270 for reset synchronization, and error logging.

In some aspects, the method 600 may be performed by the SoC 100 (FIG. 1). That is, each of the elements of the method 600 may, for example, but without limitation, be performed by the SoC 100 or one or more processors (e.g., CPU 102 and/or NPU 130) and/or other components included therein.

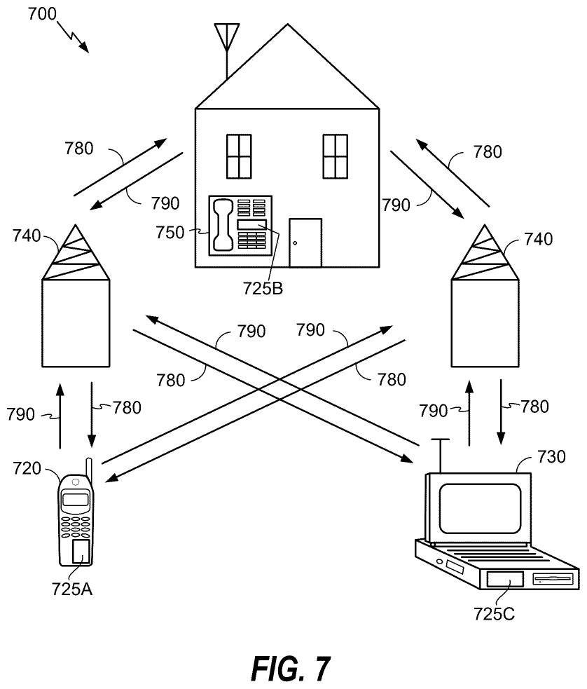

FIG. 7 is a block diagram showing an exemplary wireless communications system 700 in which an aspect of the disclosure may be advantageously employed. For purposes of illustration, FIG. 7 shows three remote units 720, 730, and 750, and two base stations 740. It will be recognized that wireless communications systems may have many more remote units and base stations. Remote units 720, 730, and 750 include IC devices 725A, 725C, and 725B that include the disclosed low latency error detection and recovery. It will be recognized that other devices may also include the disclosed low latency error detection and recovery, such as the base stations, switching devices, and network equipment. FIG. 7 shows forward link signals 780 from the base stations 740 to the remote units 720, 730, and 750, and reverse link signals 790 from the remote units 720, 730, and 750 to base stations 740.

In FIG. 7, remote unit 720 is shown as a mobile telephone, remote unit 730 is shown as a portable computer, and remote unit 750 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 7 illustrates remote units according to aspects of the present disclosure, the disclosure is not limited to these exemplary illustrated units. Aspects of the present disclosure may be suitably employed in many devices, which include the low latency error detection and recovery.

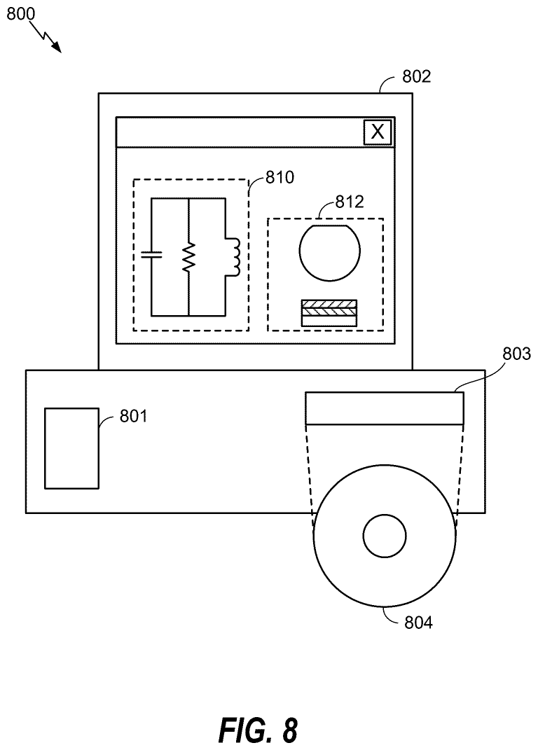

FIG. 8 is a block diagram illustrating a design workstation used for circuit, layout, and logic design of a semiconductor component, such as that of the low latency error detection and recovery technique disclosed above. A design workstation 800 includes a hard disk 801 containing operating system software, support files, and design software such as Cadence or OrCAD. The design workstation 800 also includes a display 802 to facilitate design of a circuit 810 or an integrated circuit (IC) component 812 such as the disclosed low latency error detection and recovery technique. A storage medium 804 is provided for tangibly storing the design of the circuit 810 or the IC component 812 (e.g., the low latency error detection and recovery technique). The design of the circuit 810 or the IC component 812 may be stored on the storage medium 804 in a file format such as GDSII or GERBER. The storage medium 804 may be a CD-ROM, DVD, hard disk, flash memory, or other appropriate device. Furthermore, the design workstation 800 includes a drive apparatus 803 for accepting input from or writing output to the storage medium 804.

Data recorded on the storage medium 804 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 804 facilitates the design of the circuit 810 or the IC component 812 by decreasing the number of processes for designing semiconductor wafers.

Implementation examples are described in the following numbered clauses:
1. A method for low latency error detection and recovery, the method comprising:
monitoring a serial data stream received at an image signal processor (ISP);
detecting an error status packet in the serial data stream;
determining a recovery according to a decoded error type from the error status packet; and
initiating the recovery in the ISP.
2. The method of clause 1, in which monitoring the data stream comprises analyzing a virtual channel (VC)/data type (DT) of each status packet to determine whether the status packet is the error status packet.
3. The method of any of clauses 1 or 2, in which detecting the error status packet comprises matching a virtual channel (VC)/data type (DT) of a status packet to a predetermined value to identify the status packet as the error status packet.
4. The method of any of clauses 1 or 2, in which detecting the error status packet comprises analyzing a blanking interval of the serial data stream to identity a serializer status and/or a de-serializer status.
5. The method of any of clauses 1-4, in which initiating the recovery comprises:
issuing an interrupt request (IRQ) to a subsystem of a system-on-chip (SoC) coupled to the ISP; and
determining a last programmed configuration of an ISP pipeline.
6. The method of clause 5, further comprising:
resetting a sensor, a de-serializer, and a serializer of the ISP pipeline according to the last programmed configuration; and
reprogramming the sensor, the de-serializer, and the serializer of the ISP pipeline according to the last programmed configuration in response to receiving a reset completion notification.
7. The method of any of clauses 1-6, in which the error status packet comprises a mobile industry processor interface (MIPI) packet including an error status.
8. The method of any of clauses 1-7, further comprising:
logging the decoded error type from the error status packet; and
informing a safety manager while awaiting completion of the recovery.
9. The method of any of clauses 1-8, in which the error status packet is detected at an error reception and control block of a sensor decoder of an ISP pipeline.
10. The method of any of clauses 1-9, in which detecting the error status packet comprises:
identifying a status packet in a detected blanking interval of the serial data stream; and
analyzing the status packet to determine whether the status packet is the error status packet.
11. A method for low latency error detection and recovery, the method comprising:
reading an error status in response to a detected interrupt request (IRQ);
generating an error status packet in response to the error status;
monitoring a serial data stream transmitted to an image signal processor; and
transmitting the error status packet in a detected blanking interval of the serial data stream.
12. The method of clause 11, in which generating the error status packet comprises generating a mobile industry processor interface (MIPI) packet including the error status.
13. The method of any of clauses 11 or 12, further comprising issuing the detected IRQ in response to an error detected in a serializer or a de-serializer coupled between the image signal processor and an image sensor.
14. The method of any of clauses 11 or 13, in which generating the error status packet comprises setting a virtual channel (VC)/data type (DT) to a predetermined value to identify the error status packet.
15. The method of any of clauses 11-14, in which transmitting the error status packet comprises:
inserting the error status packet in the detected blanking interval; and
transmitting the error status packet downstream in the detected blanking interval of the serial data stream.
16. An apparatus for low latency error detection and recovery, the apparatus comprising:
at least one memory; and
at least one processor coupled to the at least one memory, the at least one processor configured to:
read an error status in response to a detected interrupt request (IRQ);
generate an error status packet in response to the error status;
monitor a serial data stream transmitted to an image signal processor; and
transmit the error status packet in a detected blanking interval of the serial data stream.
17. The apparatus of clause 16, in which to generate the error status packet, the at least one processor configured to generate a mobile industry processor interface (MIPI) packet including the error status.
18. The apparatus of any of clauses 16 or 17, in which the at least one processor is further configured to issue the detected IRQ in response to an error detected in a serializer or a de-serializer coupled between the image signal processor and an image sensor.
19. The apparatus of any of clauses 16 or 18, in which to generate the error status packet, the at least one processor configured to set a virtual channel (VC)/data type (DT) to a predetermined value to identify the error status packet.
20. The apparatus of any of clauses 16-19, in which to transmit the error status packet, the at least one processor is further configured to:
insert the error status packet in the detected blanking interval; and
transmit the error status packet downstream in the detected blanking interval of the serial data stream.

For a firmware and/or software implementation, the methodologies may be implemented with modules (e.g., procedures, functions, etc.) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on a non-transitory computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for low latency error detection and recovery, the method comprising:
monitoring a serial data stream received at an image signal processor (ISP);
detecting an error status packet in the serial data stream;
determining a recovery according to a decoded error type from the error status packet; and
initiating the recovery in the ISP.

2. The method of claim 1, in which monitoring the data stream comprises analyzing a virtual channel (VC)/data type (DT) of each status packet to determine whether the status packet is the error status packet.

3. The method of claim 1, in which detecting the error status packet comprises matching a virtual channel (VC)/data type (DT) of a status packet to a predetermined value to identify the status packet as the error status packet.

4. The method of claim 1, in which detecting the error status packet comprises analyzing a blanking interval of the serial data stream to identity a serializer status and/or a de-serializer status.

5. The method of claim 1, in which initiating the recovery comprises:
issuing an interrupt request (IRQ) to a subsystem of a system-on-chip (SoC) coupled to the ISP; and
determining a last programmed configuration of an ISP pipeline.

6. The method of claim 5, further comprising:
resetting a sensor, a de-serializer, and a serializer of the ISP pipeline according to the last programmed configuration; and
reprogramming the sensor, the de-serializer, and the serializer of the ISP pipeline according to the last programmed configuration in response to receiving a reset completion notification.

7. The method of claim 1, in which the error status packet comprises a mobile industry processor interface (MIPI) packet including an error status.

8. The method of claim 1, further comprising:
logging the decoded error type from the error status packet; and
informing a safety manager while awaiting completion of the recovery.

9. The method of claim 1, in which the error status packet is detected at an error reception and control block of a sensor decoder of an ISP pipeline.

10. The method of claim 1, in which detecting the error status packet comprises:
identifying a status packet in a detected blanking interval of the serial data stream; and
analyzing the status packet to determine whether the status packet is the error status packet.

11. A method for low latency error detection and recovery, the method comprising:
reading an error status in response to a detected interrupt request (IRQ);
generating an error status packet in response to the error status;
monitoring a serial data stream transmitted to an image signal processor; and
transmitting the error status packet in a detected blanking interval of the serial data stream.

12. The method of claim 11, in which generating the error status packet comprises generating a mobile industry processor interface (MIPI) packet including the error status.

13. The method of claim 11, further comprising issuing the detected IRQ in response to an error detected in a serializer or a de-serializer coupled between the image signal processor and an image sensor.

14. The method of claim 11, in which generating the error status packet comprises setting a virtual channel (VC)/data type (DT) to a predetermined value to identify the error status packet.

15. The method of claim 11, in which transmitting the error status packet comprises:
inserting the error status packet in the detected blanking interval; and
transmitting the error status packet downstream in the detected blanking interval of the serial data stream.

16. An apparatus for low latency error detection and recovery, the apparatus comprising:
at least one memory; and
at least one processor coupled to the at least one memory, the at least one processor configured to:
read an error status in response to a detected interrupt request (IRQ);
generate an error status packet in response to the error status;
monitor a serial data stream transmitted to an image signal processor; and
transmit the error status packet in a detected blanking interval of the serial data stream.

17. The apparatus of claim 16, in which to generate the error status packet, the at least one processor configured to generate a mobile industry processor interface (MIPI) packet including the error status.

18. The apparatus of claim 16, in which the at least one processor is further configured to issue the detected IRQ in response to an error detected in a serializer or a de-serializer coupled between the image signal processor and an image sensor.

19. The apparatus of claim 16, in which to generate the error status packet, the at least one processor configured to set a virtual channel (VC)/data type (DT) to a predetermined value to identify the error status packet.

20. The apparatus of claim 16, in which to transmit the error status packet, the at least one processor is further configured to:
insert the error status packet in the detected blanking interval; and
transmit the error status packet downstream in the detected blanking interval of the serial data stream.
